(19) United States
(12) Patent Application Publication
(10) Pub. No.: US 2012/0221753 A1
(43) Pub. Date: Aug. 30, 2012

(54) METHOD AND DEVICE FOR WAKING UP USERS IN A BUS SYSTEM AND CORRESPONDING USERS

(76) Inventor: Florian Hartwich, Reutlingen (DE)

(21) Appl. No.: 13/391,244

(22) PCT Filed: Sep. 15, 2010
(86) PCT No.: PCT/EP2010/063534

§ 371 Date: May 11, 2012

(30) Foreign Application Priority Data
Sep. 16, 2009 (DE) 10 2009 041 434.7

(51) Int. Cl. G06F 13/36

(52) U.S. Cl. 710/107

(57) ABSTRACT

An apparatus for waking up users of a CAN bus system, a sensing element being provided which senses at least one predefined signal property of the signals transmitted on the bus system and the further wakeup operation being initiated as a function of the behavior of the at least one sensed signal property, wherein at least two profiles, patterns, or sequences of one of the at least one signal property are defined, one profile or pattern or sequence being used for waking up a group of users, and a second profile or a second pattern or a second sequence being used for individually waking up a user.

### FIELD OF THE INVENTION

The present invention relates to a method and an apparatus for waking up users of a bus system, and from a corresponding user.

### BACKGROUND INFORMATION

Control devices in motor vehicles are, to an increasing extent, continuously supplied with voltage (also called “terminal 30” capability) so that certain monitoring and control functions can be performed even with the ignition switched off. These can be instances of, for example, access and driving authorization, or diagnosis. To reduce power consumption, the control devices are put into a so-called “sleep” mode. This is done either by switching off the voltage regulator or by entering into a corresponding operating mode of the microcontroller.

The control device must be woken up when necessary. This occurs by way of a lead, provided for the purpose, either to a wakeup input of the microcontroller of the user or to a wakeup input of the voltage regulator. In present-day systems, which are usually networked, it can also occur by way of an activity on the bus lines.

A disadvantage of this is that either a separate wakeup lead must be routed to all required control devices; or in the case of waking via the bus, all the control devices (including those not required) are woken by a desired or undesired bus activity, either by communication on the bus or by interference on the bus.

Present-day CAN transceivers can be operated substantially in two modes: in the active mode for communication, and in the sleep mode for the power-saving idle state. The application program can set the desired operating mode; the transceiver also switches, in particular automatically, from the sleep mode into the active mode as soon as it detects a signal or a signal property, e.g., a dominant bit, on the CAN bus. While the transceiver is in sleep mode, the remainder of the CAN node can be switched off and is then switched back on when the CAN transceiver switches into the active mode.

German Patent Application No. DE 103 58 584 A1 describes a method by which a CAN transceiver is expanded to include a circuit that decodes 8-bit-long patterns from an 8-byte-long data field of a CAN message. As a result, the CAN transceiver can be operated in four modes. In addition to the modes previously described, there is also a further economy mode and an intermediate mode. The transceiver automatically switches from the sleep mode into the economy mode as soon as it detects a dominant bit on the CAN bus. In the economy mode, it senses a signal property and switches into the intermediate mode when it detects a number of signal properties, for example edges, within a predefined time span. It then switches from the intermediate mode into the active mode only as soon as it detects a specific pattern in the 8-byte-long data field of the re-transmitted CAN message, which it decodes for that purpose according to a specific method. This wakeup pattern can be configured separately for each CAN transceiver. The CAN identifier of this message is predefined for this method. If it does not detect the wakeup pattern in this message, it goes back into economy mode. The power consumption in the intermediate mode is only slightly higher than in the economy mode; the remainder of the CAN node can remain switched off. This makes possible CAN networks in which individual nodes remain in controlled fashion in the power-saving economy mode, while the other nodes communicate via the CAN bus. The individual nodes can be selectively woken up from the economy mode. This is also called “selective wakeup.”

It is thus possible, via the bus used in motor vehicles (in particular a CAN bus), to selectively wake up only the control devices that are needed in order to perform the necessary functions.

### SUMMARY

An object of the present invention is to provide an optimized method for allowing both individual nodes and groups of nodes in a CAN network to be woken simultaneously.

In accordance with the present invention, a method and an apparatus are provided for waking up users of a bus system, a sensing element being provided which senses at least one predefined signal property of the signals transmitted on the bus system, and the further wakeup operation is initiated therefrom, wherein at least two profiles, patterns, or sequences of one of the at least one signal property, in particular patterns, are defined, one being used for waking up a group and a second for individual waking.

Advantageously, an edge or an edge transition of the signal is provided as a predefined signal property.

A signal level or a specific combination of several signal levels can likewise usefully be provided as a predefined signal property.

It is particularly advantageous if upon occurrence of one of the at least one signal property, a time duration is determined; and there results from the time duration thereby determined, after the first occurrence, from the signal properties referred to the time duration, a binary information that enables a selective wakeup of users of the bus system.

The user to be woken up can be read out from the information obtained; this can be accomplished by analysis of the bulletin or message that has led to authorization of the sleep mode, or also of a re-transmitted further wakeup bulletin or message.

Advantageously, the control devices connected to the bus can entirely switch off their microcontrollers, or put them into a sleep mode having clocks likewise switched off, such that only the transceiver connected to the bus, in particular a CAN transceiver of very low power consumption, needs to be supplied with standby power. By using, according to the present invention, the time duration that is determined upon occurrence of the signal property, decoding can occur irrespective of the bus system transfer rate that is used, and errors in the block structure with respect to the communication blocks in the bus system can additionally be detected by way of the evaluation.

It is particularly advantageous if the message is re-transmitted after initiation of the further wakeup operation, and a determination is made therefrom as to which users are then, selectively, to be completely woken up. Incorrect interpretations of messages as wakeup messages can thereby be effectively avoided. Both steps of the wakeup operation can, however, also be cycled through in the course of evaluation of a single message.

The configuration capabilities for the wakeup method via the CAN transceiver having a selective wakeup function are expanded by the method according to the present invention, since it is not only one pattern that is configured, but at least two.

The advantage of this method is that the application program can, with a single CAN message, simultaneously wake up multiple CAN nodes from the economy mode. This saves time and bandwidth on the CAN bus. The possibility of waking up individual CAN nodes is retained.

Further advantages and advantageous embodiments are described below.

### BRIEF DESCRIPTION OF THE DRAWINGS

The present invention is explained in further detail with reference to the figures.

FIG. 1 shows a bus system having several, at least two, users.

FIG. 2 shows an example method sequence according to the present invention in the form of a flow chart.

FIG. 3 depicts, by way of example, a bulletin having the wakeup information encoded in the data field.

FIG. 4 shows an example structure according to the present invention of a block in the data field for identifying the signal property having encoded information.

FIG. 5 shows, by way of example, the subdivision of the encoded wakeup information into a group wakeup information and individual wakeup information.

### DETAILED DESCRIPTION OF EXAMPLE EMBODIMENTS

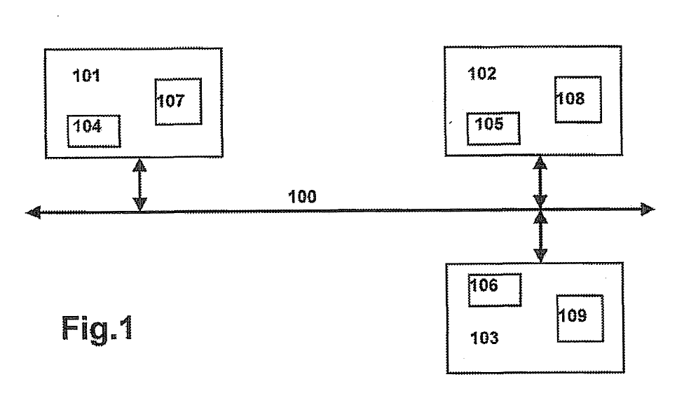

FIG. 1 shows a bus system 100 having bus users 101, 102, and 103. The latter each contain a transceiver or a media connector unit 107, 108, 109 respectively, as well as a time-sensing or counting module having an integrated clock 104, 105, or 106. The latter can in each case be located outside the corresponding transceiver or media connector unit, but can also be expressed as a constituent thereof. As already mentioned, in this exemplifying embodiment only those control devices that are needed to perform the required functions are to be selectively woken via the CAN bus that is often used in motor vehicles. Devices can also be combined into groups that react to the same wakeup information.

One possibility would be to use specific parts of a message or of a CAN frame (e.g., identifier) for selection. A prerequisite for this, however, is that the wakeup device be continuously connected to a clock that is in operation; this, however, makes a substantial contribution to power consumption. This kind of wakeup requires that the transfer rate of the bus be known, and that the clock must exhibit only very small fluctuations as a result of external influences such as, for example, supply voltage or temperature, etc. The exact object thus consists in applying or developing a selection method that operates in multiple stages, and that in the first stage makes do without clocks that are in operation.

In the idle state, the control devices or users that are connected to the bus, for example 102 and 103, can switch off their microcontrollers completely or put them into a state with a switched-off clock. The time-sensing or counting module having clock 105 or 106, respectively, is also put into a sleep mode in which the integrated clock is switched off. In the users in the idle state, for example 102 and 103, only the CAN transceiver connected to the bus, or the media connector unit, having a very low power consumption, is supplied with standby power.

The selection mechanism becomes activated when a user, for example 101, transmits on the bus a characteristic signal for waking up users 102 and/or 103. In a first step, users 102 and 103 switch into the economy mode and count edges of the transmitted bus signal. The time-sensing or counting module having clock 105 or 106 becomes activated. The switchover into the intermediate state occurs as a function of the result of the edge count. In the intermediate state, the content of the data field is decoded with the aid of clock 105 or 106, and is compared with a stored wakeup address. In the event of a positive result, the user switches into the active mode and, for example, the microcontrollers and/or further voltage regulators of users 102 and 103, respectively, become activated.

The present invention can be implemented as a single-stage wakeup concept in which both steps of the method are cycled through based on the evaluation of a single received message. It can also, however, in order to further enhance wakeup reliability, be executed as a two-stage wakeup concept in which the two steps of the method are cycled through based on the evaluation of two successively received messages.

If multiple devices react to the same wakeup mechanisms, or to the same characteristic signals, then entire groups of devices can also be woken; or the devices can be combined into groups. The possibility of also waking up specific devices for specific applications is at the same time retained by way of the procedure according to the present invention.

By way of the logical structure it is possible to derive the items of information from the message irrespective of the transfer rate used, as will be explained in further detail below. In this context, the number of changes between High and Low, or 0 and 1, i.e., the binary information, is largely constant.

It is particularly preferred that the wakeup message be a bulletin that is constructed according to the CAN bus ISO standard, that does not violate said standard and thus causes no problems in existing systems. A CAN controller, as used in other approaches, is then not necessary here.

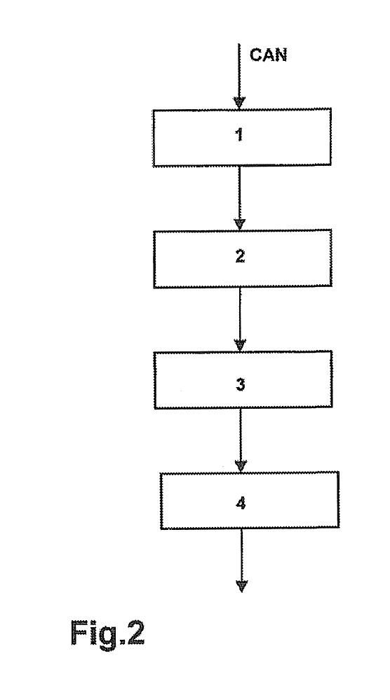

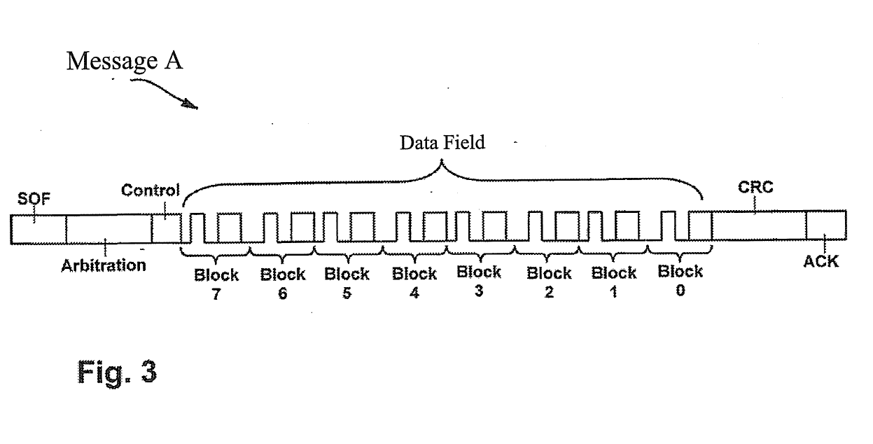

FIG. 2 depicts a schematic flow chart as an example. The sender of the wakeup request sends on the bus, such as a CAN bus in the example here, a message A in accordance with FIG. 3, in which message the receiver or receiver group to be woken up is encoded with a number. In the idle state, the bus is recessive. When the first bulletin comes (which can be detected by the switchover to dominant and occurs in block 1 of FIG. 2), a counter is activated. Concurrently, the clock of time-sensing or counting module 105 or 106 is started. The number of edges, or also the signal level, of the bulletin in block 2 of FIG. 2 is then counted over a specific time that is influenced by multiple factors. If this number is within the permissible limits, the second part of the circuit is activated. A first separation is thereby achieved between communication or interference on the bus, and a wakeup request. If this comparison turns out positive, i.e., if a wakeup request exists, the second stage of the logic system is supplied with power. The sender then sends message A corresponding to FIG. 3 a second time. From this the wakeup logic system, i.e., in particular the processing unit, reads out from the data field using time-sensing or counting module 105, 106, in accordance with the example method discussed below, the number of the device or device group that is to be woken up. This occurs in block 3 of FIG. 2. If the number read out matches a stored one, the device is then activated in block 4 of FIG. 2 by activating the voltage regulators or waking up the microcontroller, and the corresponding user participates in bus traffic. In accordance with the example method according to the present invention, this can be the case only for an individual user, but also for a group of users, so that in the latter case multiple users are woken up with one wakeup message. In this flow chart, the two-stage wakeup method is depicted with the combination of blocks 2 and 3, as described above. It is likewise possible to use only one of the two stages as a wakeup criterion.

According to FIG. 3, message A is used in a preferred form as a message constructed according to the CAN bus ISO standard. A “start of frame” (SOF), an arbitration field that as a rule contains the identifier, and a control field are provided before the data field. Contained after the data field is a check number as a cyclic redundancy check (CRC), and a confirmation field with regard to the bulletin transfer (an acknowledgment ACK). Message A contains the number of the device or device group in the data field. The CAN identifier used can be the wakeup ID, i.e., rrr rrrd rrrr in accordance with CAN Specification 2.0, where “r” signifies “recessive” and “d” signifies “dominant.” A different message address can, however, also be defined for the wakeup message. The frame thus conforms to the CAN bus specification, and communication by other devices via the CAN bus is not disrupted.

As depicted in FIG. 3, the entire data field in the frame, in particular in the CAN frame, is made up here of 64 bits subdivided into eight blocks, i.e., block 0 to block 7. At least one bit of the device number is encoded in each block. If exactly one bit of the device number is encoded in each block, the circuit can obtain, from a CAN frame as depicted, eight bits for further processing. Transfer errors can be detected by way of the interleaving of these eight bits.

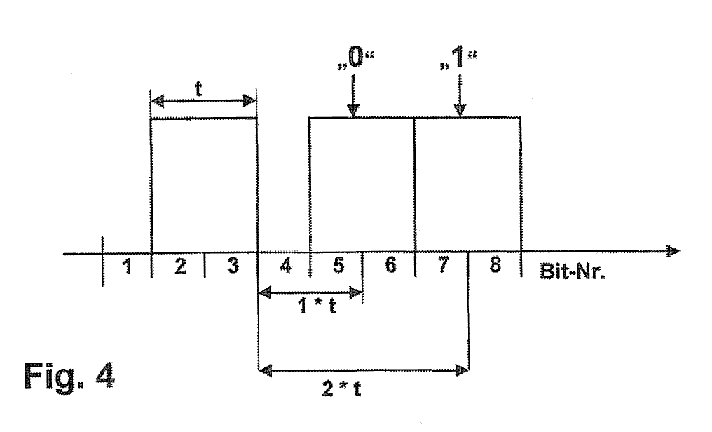

The particular structure of the individual blocks 0 to 7 of FIG. 3 is depicted in FIG. 4. As a result of this particular structure of the eight blocks, coding can occur irrespective of the bus transfer rate that is used. In addition, errors in the block structure can still be detected. In this context, one block corresponds to eight bits from the CAN data field.

The structure of a block is depicted by way of example in FIG. 4. Here bits 2 and 3 are High in order to measure or determine a time t. After the end of bit 3, the wakeup logic or processing unit waits once for the previously determined time t and stores the state that then occurs, then waits for time t once again and stores the new state that then occurs. The times t and 2 t as depicted in FIG. 4 can be selected so that High or Low signals can be entirely detected in the context of the signal levels. Also possible is a detection of the signal edges, for example from bit 4 to bit 5 and bit 6 to bit 7, by corresponding selection of the respective time segments. What results is a coding capability, irrespective of the transfer rate used, for a 0 information (here in bits 5 and 6) and a 1 information (here via bits 7 and 8).

In other words, in the coding example in FIG. 4, bit 1 is always 0 and bit 2 and bit 3 are always 1, in order to calibrate time t; and bit 4 is in turn always 0 for separation between the calibration time and the actual binary information. Bits 5 and 6 are selected here so that they are at High, which then means a logical 0 for the block. Bits 7 and 8 are then selected in such a way, which would signify a logical 1 for the block. In other words, if bits 5 and 6 are at 1, the block then contains a logical 0; and if bits 7 and 8 are at 1, the block contains a logical 1. In other words, the bits are set here so that either bits 5 and 6 are at 1, or bits 7 and 8. In other words, the example method described exhibits a baud-rate-independent transfer, in particular by counting edges or edge transitions, or the corresponding signal level, in accordance with the respectively predefined signal property: on the one hand as a first wakeup stage and, in the context of evaluation of the encoded binary information in the same message or in a re-transmitted message, as a second, selective wakeup stage, in a multi-stage concept. The predefined signal property can be, as already mentioned, on the one hand the signal level (i.e., 0 or 1 as in the example of FIG. 4) but also, as already stated, evaluation of the signal edges or of the signal edge transition. What results is a simple capability for selectively waking up control devices without entailing additional circuit complexity and without always producing power consumption by all the users of the bus system, including those that are not needed.

The configuration capabilities for the CAN transceiver having a selective wakeup function are expanded by the present invention such that not only one pattern, but instead at least two, are configured. One pattern serves for individual waking of an individual user, and the further pattern(s) for waking groups of users. By suitable selection of the configured patterns, it is possible to arrange matters so that not all the wakeup patterns need to be separately stored or configured.

The advantage of this method is that the application program can, with a single CAN message, simultaneously wake up multiple CAN nodes from the economy mode. This saves time and bandwidth on the CAN bus. The possibility of waking up individual CAN nodes is retained as a result of the second pattern.

There are generally four possibilities for configuring ICs, such as, e.g., CAN transceivers, in accordance with a wakeup functionality:

1. Fixed coding in the IC (ROM)

2. Volatile memory that must be externally reset (e.g. via SPI) after each switch-on

3. Nonvolatile memory that is programmed at the end of the assembly line (EPROM, EEPROM, flash)

4. Bit zapping (individual bits are set permanently at the end of the assembly line using fuse/antifuse technology).

Version 1 is suitable when production volumes for each individual coding are very high.

Version 2 requires a separate programming interface.

Version 3 results in higher costs (additional process steps) in production.

Version 4 can be used for a small number of bits.

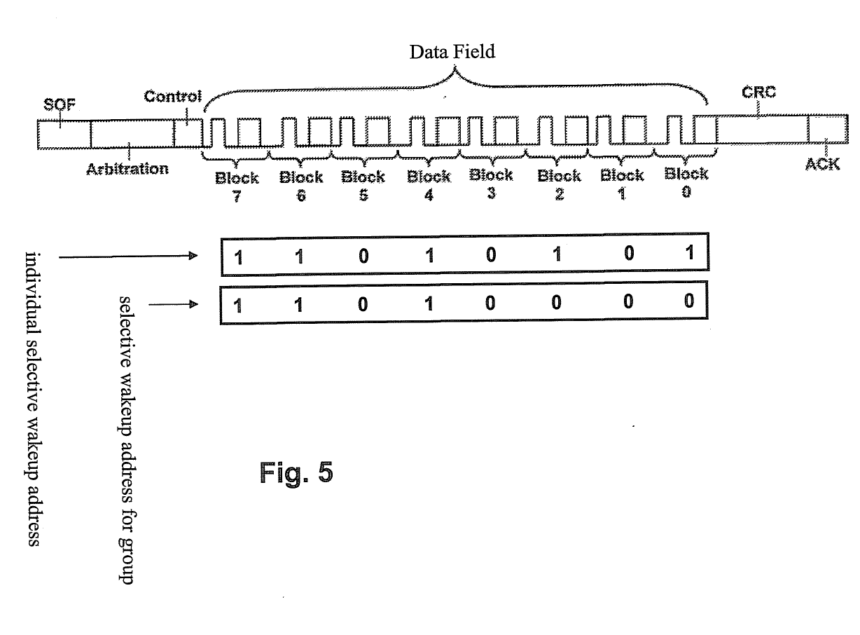

When multiple CAN nodes are configured with the same wakeup pattern, these CAN nodes can be woken up simultaneously but not individually. It is therefore useful to enable an alternative wakeup pattern. Each CAN node can then have a separate wakeup pattern; groups of CAN nodes use the same alternative wakeup pattern, with which they can be woken simultaneously. An example is discussed below and depicted in FIG. 5.

In order to minimize the number of configuration bits (especially for the zapping configuration), the alternative wakeup patterns are specially coded; for example, n bits of the wakeup pattern are selected so as to define (2ⁿ−1) separate wakeup patterns and one group wakeup pattern. The remaining (8−n) bits of the wakeup pattern are identical for nodes of that wakeup group. If a wakeup group is thus intended to be made up of, for example, seven CAN nodes, then, for example, the last three bits of the wakeup pattern are used in order to wake up individual nodes separately. Three bits yield eight combinations. For example, with the combinations 1 to 7 the members of the wakeup group are woken up separately, and with combination 0 all of them are woken up simultaneously. Both a separate and an alternative wakeup pattern thus exists for each node, without an additional need for configuration bits. The aforesaid selection, chosen in the example depicted in FIG. 5, of the wakeup patterns means that the setting operation in the context of configuration, for example by bit zapping, is limited to the individual, selective bit pattern. When the user receives its individual wakeup pattern (11010101 in the example depicted, or when it receives its first five bits with three subsequent logical zeros (i.e. 11010000), it is thus woken up. The wakeup pattern valid for the group is thereby implicitly also stored.

Other codings and other values of wakeup groups are, of course, likewise possible.

The CAN transceivers described here can be used for CAN and/or for TTCAN networks.

1-15. (canceled)

16. An apparatus for waking up users of a CAN bus system, comprising:
a sensing element which senses at least one predefined signal property of signals transmitted on the bus system, a wakeup operation being initiated as a function of the at least one sensed signal property; and
wherein one of: i) at least two profiles, ii) at least two patterns, or iii) at least two sequences of one of the at least one signal property are defined, one of the profiles, or patterns, or sequences being used for waking up a group of users, and a second one of the profiles, patterns, or sequences being used for individually waking up a user.

17. The apparatus as recited in claim 16, wherein the sensing element is configured to sense one of an edge or an edge transition of the signal, as a predefined signal property.

18. The apparatus as recited in claim 17, wherein the sensing element is configured to sense one of a signal level or a specific combination of several signal levels, as a predefined signal property.

19. The apparatus as recited in claim 17, further comprising:
a counter to count an occurrence of one of the at least one signal property.

20. The apparatus as recited in claim 17, further comprising:
one of a counter or timer, the one of the counter or timer to sense a time duration between occurrence times of sensed signal properties.

21. The apparatus as recited in claim 17, further comprising:
a memory to store the profiles, patterns, or sequences of the at least one signal property used for the wakeup operation.

22. A method for waking up users of a CAN bus system, comprising:
sensing, by a sensing element, at least one predefined signal property of signals transmitted on the bus system; and
initiating a wakeup operation as a function of the at least one sensed signal property, wherein one of: i) at least two profiles, ii) at least two patterns, or iii) at least two sequences of one of the at least one signal property are defined, one of the profiles, patterns, or sequences being used for waking up a group of users, and a second one of the profiles, patterns, or sequences being used for individually waking up a user.

23. The method as recited in claim 22, further comprising:
sending a message;
evaluating the message as a wakeup message by sensing; and
evaluating one or more of the at least one signal property from the message.

24. The method as recited in claim 23, further comprising:
counting one of the at least one signal property by a counter; and
comparing the count with at least one threshold value or limit value;
wherein the wakeup operation is initiated as a function of the result of the comparison.

25. The method as recited in claim 22, further comprising:
determining a time duration upon occurrence of one of the at least one signal property.

26. The method as recited in claim 25, further comprising:
ascertaining binary information from a value of one of the at least one signal property after a previously determined time duration has elapsed again at least once;
creating a profile, a sequence, or a pattern of a signal property from several items of the binary information; and
comparing the created profile, sequence, or pattern of the signal property with at least one of the determined profiles, sequences, or patterns, wherein as a function of a result of the comparison, the wakeup operation is or is not initiated.

27. The method as recited in claim 22, wherein in a first step, one of the at least one signal property is counted by a counter and is compared with at least one of the threshold value or limit value, and the wakeup operation is initiated as a second step as a function of a result of the first comparison; and
wherein in a second step, a time duration is ascertained from a value of one of the at least one signal property, and a binary information is ascertained after the ascertained time duration has elapsed again at least once, wherein from several items of the binary information ascertained, one of a profile, a sequence, or a pattern of a signal property is created and is compared with at least one of the defined profiles, sequences, or patterns, and as a function of a result of the second comparison the wakeup operation is or is not carried out.

28. The method as recited in claim 22, wherein wakeup messages are sent several times, and a message received in an idle state is evaluated as a wakeup message, and after initiation of the wakeup operation, execution waits for another reception of the wakeup message, and after another reception the second step, selective for individual users or groups of users, of the wakeup operation is carried out.

29. The method according to claim 27, wherein a message received in an idle state is evaluated as a wakeup message, the first step of the wakeup method and the second step, selective for individual users or groups of users, of the wakeup method, being carried out by evaluating a same message that is received once.

30. A user of a bus system, comprising:
a sensing element which senses at least one predefined signal property of signals transmitted on the bus system, a wakeup operation being initiated as a function of the at least one sensed signal property; and
wherein one of: i) at least two profiles, ii) at least two patterns, or iii) at least two sequences of one of the at least one signal property are defined, one of the profiles, or patterns, or sequences being used for waking up a group of users, and a second one of the profiles, patterns, or sequences being used for individually waking up a user.
